(19) United States
(12) Patent Application Publication
(10) Pub. No.: US 2008/0275979 A1
(43) Pub. Date: Nov. 6, 2008

(54) System and method for clustering of group-centric networks

(75) Inventor: Nelson Saba, Orlando, FL (US)

Correspondence Address: CARR & FERRELL LLP, 2200 GENG ROAD, PALO ALTO, CA, 94303, US

(73) Assignee: Blaksley Ventures 108, LLC

(21) Appl. No.: 12/217,935

(22) Filed: Jul. 9, 2008

Related U.S. Application Data
(63) Continuation-in-part of application No. 11/728,218, filed on Mar. 23, 2007.
(60) Provisional application No. 60/899,092, filed on Feb. 2, 2007.
(60) Provisional application No. 60/959,019, filed on Jul. 9, 2007.

(51) Int. Cl. G06F 15/16

(52) U.S. Cl. 709/223

(57) ABSTRACT

Exemplary systems and methods for managing a plurality of group-centric networks are provided. In exemplary embodiments, a plurality of group-centric networks is established within a network cluster. Each group-centric network comprises one or more groups having a common interest. Once established, the group-centric network defines customized administrative components for the group-centric network. In exemplary embodiments, the administrative component comprises roles and relationship definitions which define what data and functionality may be provided to a user accessing a group within the group-centric network.

### CROSS-REFERENCE TO RELATED APPLICATIONS

The present application claims priority benefit of U.S. Provisional Patent Application No. 60/959,019, filed Jul. 9, 2007 and entitled “System and Method for Clustering of Group-Centric Networks,” which is incorporated by reference. The present application is also a continuation-in-part of U.S. patent application Ser. No. 11/728,218, filed Mar. 23, 2007 and entitled “Creation of Organizational Hierarchies in a Group-Centric Network via Handshake Mechanisms,” which, in turn, claims the benefit of U.S. Provisional Patent Application No. 60/899,092 filed Feb. 2, 2007 and entitled “Group-Centric Social Networking,” both of which are incorporated by reference.

The present application is related to U.S. patent application Ser. No. 12/012,797, entitled “Criteria-Based Creation of Organizational Hierarchies in a Group-Centric Network” and U.S. patent application Ser. No. 12/012,796, entitled “Roles and Relationship Based Security in a Group-Centric Network,” both filed on Feb. 4, 2008, both of which claim the benefit of U.S. Provisional Patent Application No. 60/899,092, and both hereby incorporated by reference. The present application is also related to co-pending U.S. patent applications entitled “System and Method for Managing a Plurality of Network Clusters,” and “System and Method for Providing Universal Profiles for Networked Clusters,” filed on Jul. 9, 2008, all of which are herein incorporated by reference.

### BACKGROUND

1. Field of the Invention

Embodiments of the present invention are directed to networking and more particularly to management of a plurality of group-centric networks.

2. Related Art

Presently, users may utilize social networks to communicate with others in a social environment. These social networks are typically a collection of individuals accessing a single social network host, and typically represent a collection of relationships between the users. In some embodiments, the social network is a map of relationships between the users, which indicate ways in which the users are connected through various social familiarities ranging from casual acquaintance to close familial bonds, for example. The relationships maybe created between two users via an invitation or request between the users.

Typically, each user within the social network has their own web page on which any information the user desires to present may be posted. Some information on the web page may be private, such that only those with relationships with the user can view the private information. Other information may be public, such that any member of the social network may be able to view the public information.

Networks of generic users or organization may be present on the Internet. However, these networks are not organized in a manner whereby the networks can be clustered together in multiple ways based on their affinities. Additionally, constructs are not available to represent organizations robustly enough to make them functional over the Internet by allowing its functions to be performed according to entitlements pertinent to the nature and activity of a group in the organization.

### SUMMARY OF THE INVENTION

Embodiments of the present invention provide systems and methods for managing a plurality of group-centric networks. In exemplary embodiments, a plurality of group-centric networks is established within a network cluster. Each group-centric network comprises one or more groups/organizations having a common interest or affinity. As such, each network cluster may be subject matter or topic specific.

A network host may be configured to establish, maintain, and manage the network cluster. In exemplary embodiments, the network host may receive account information for establishing the group-centric network within the network cluster. The account information may be filtered, approved, or denied.

In some embodiments, a message-based handshake mechanism may be performed to approve or activate the group-centric network (or groups of the group-centric network) within the network cluster. A message-based handshake may comprise a “join” handshake (e.g., for an established group-centric network to join the network cluster), a “belong” handshake (e.g., for establishing a new group-centric network in the network cluster), and an “invitation” handshake (e.g., for inviting and accepting an invitation to join or belong to the network cluster).

The group-centric network may define customized administrative components for groups within the group-centric network. The customized administrative components may comprise profile segments, web parts, subgroup types, and roles/relationships for the groups. In exemplary embodiments, the administrative component comprises roles and relationship definitions which define what data and functionality may be provided to a user accessing a group within the group-centric network.

### BRIEF DESCRIPTION OF THE DRAWINGS

FIG. 1 is a diagram of a super cluster according to exemplary embodiments.

FIG. 2a is a block diagram of an exemplary network cluster.

FIG. 2b is a block diagram of an example network cluster.

FIG. 2c is a block diagram of an example of overlapping network clusters.

FIG. 3 is a block diagram of an exemplary hierarchical structure within one group-centric network.

FIG. 4 is a block diagram of an exemplary cluster network host.

FIG. 5 is a block diagram of an exemplary accounts engine of the cluster network host.

FIG. 6 is a block diagram of an exemplary messaging engine of the cluster network host.

FIG. 7 is a block diagram of an exemplary administrative engine of the cluster network host.

FIG. 8 is a flowchart of an exemplary method for managing a network cluster.

### DETAILED DESCRIPTION OF EXEMPLARY EMBODIMENTS

Embodiments of the present invention provide systems and methods for managing a plurality of group-centric networks within a group-centric network cluster. For simplicity, these group-centric network clusters may be herein referred to as network clusters. In various embodiments, each network cluster is a collection of common-interest or topic specific group-centric networks associated with a particular subject matter. Each group-centric network allows related organizations to be represented and made functional over a communication network, such as the Internet. Groups, projects, and services of each organization may then be connected through managerial, functional, and business relationships, established within and according to an organizational structure. According to some embodiments, the group-centric network may comprise a group-centric social network. In alternative embodiments, the group-centric network may comprise a group-centric enterprise, business, or educational network, or any other type of group based network.

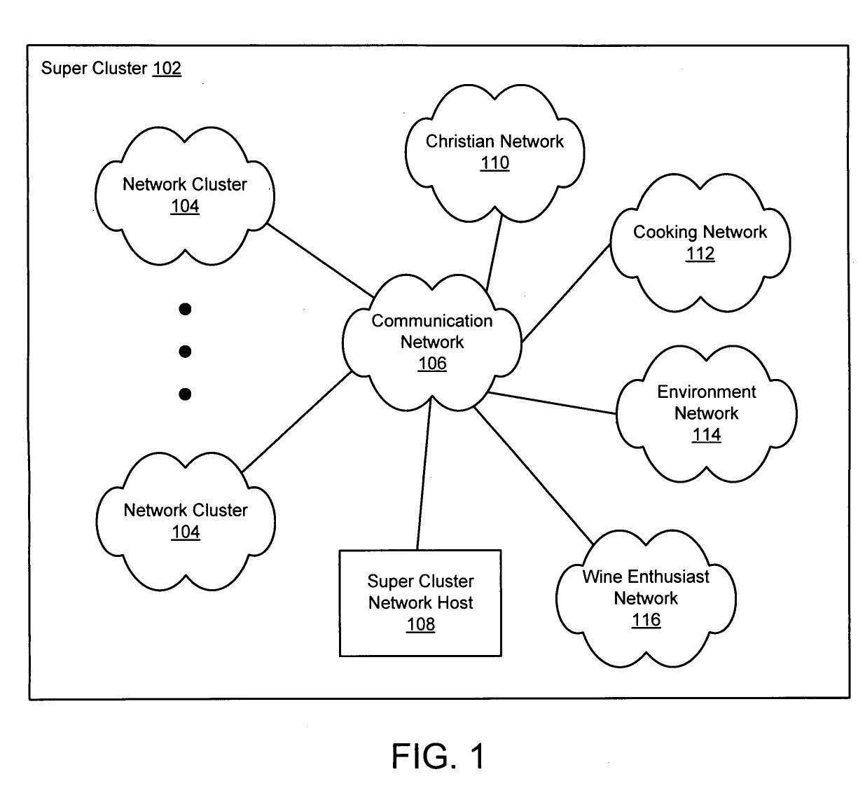

Referring to FIG. 1, a general environment in which embodiments of the present invention may be practiced is shown. In exemplary embodiments, a super cluster 102 comprises a plurality of network clusters 104 coupled in communication in a communication network 106. The super cluster 102 may be administered via a super cluster network host 108. More details regarding the super cluster network host 108 may be found in co-pending U.S. patent application Ser. No. ______, filed Jul. 9, 2008 and entitled “System and Method for Managing a Plurality of Network Clusters,” which is incorporated by reference.

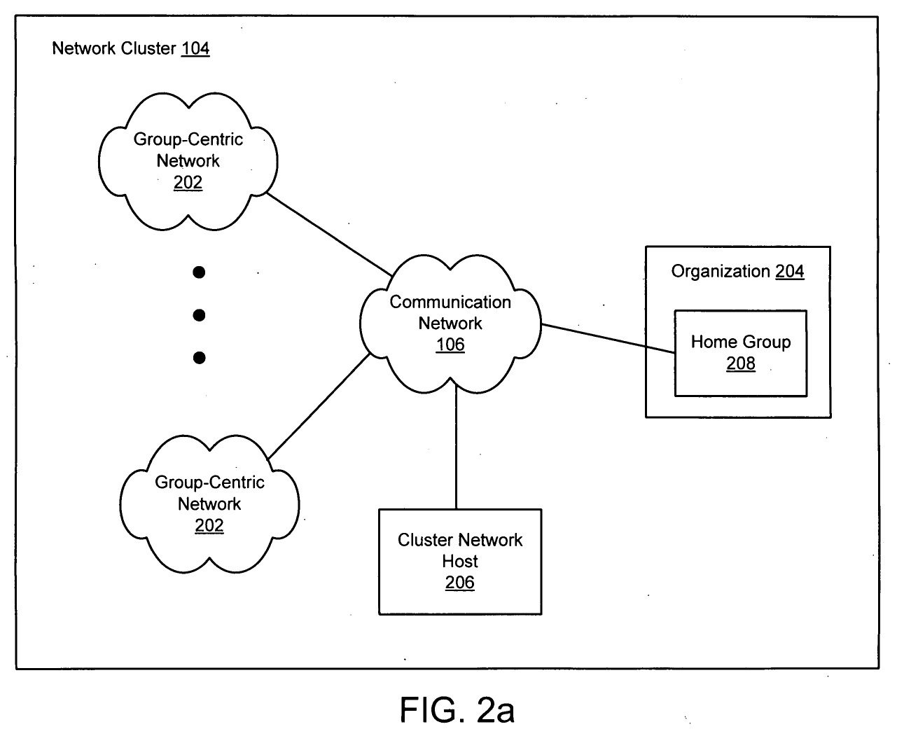

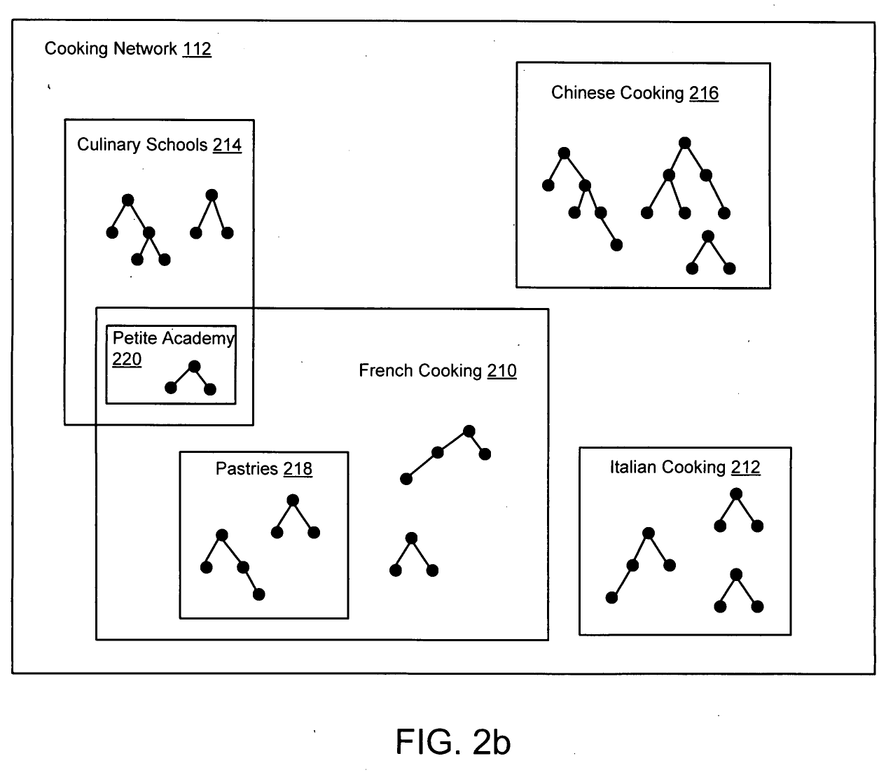

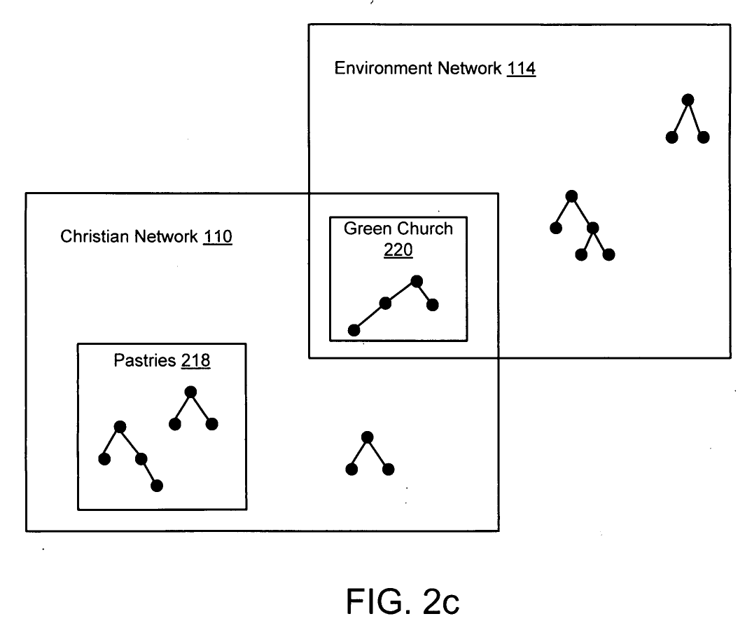

Each network cluster 104 comprises a plurality of related organizations, as will be discussed in more details in connection with FIG. 2a to FIG. 2c. In exemplary embodiments, each network cluster 104 is directed to a particular theme, common goal, or association. For example, the network clusters 104 may represent a Christian network 110, a cooking network 112, an environment network 114, wine enthusiast network 116, or any other collection of organizations or groups having a common interest or goal. As such, the super cluster 102 may be a collection of unrelated network clusters 104.

It should be noted that FIG. 1 illustrates one exemplary embodiment of the super cluster 102. Alternative embodiments may comprise any number of network clusters 104 coupled to any type of communications network 106. Additionally, more than one super cluster network host 108 may be present. It should also be noted that embodiments of the present invention may be practiced outside the scope of a super cluster 102. That is, the network clusters 104 may operate in an environment without a super cluster 102.

Referring now to FIG. 2a, the network cluster 104 is shown in more detail. The exemplary network cluster 104 comprises a plurality of group-centric networks 202 coupled via the communication network 106. Each group-centric network 202 may represent an organization 204 or specific group(s) of with similar interests. For example, Green Church may be an organization in the Christian network 110, or fusion cooking may be a specific group in the cooking network 112. In some embodiments, the group-centric network 202 may comprise more than one organization 204 or set of organizations 204.

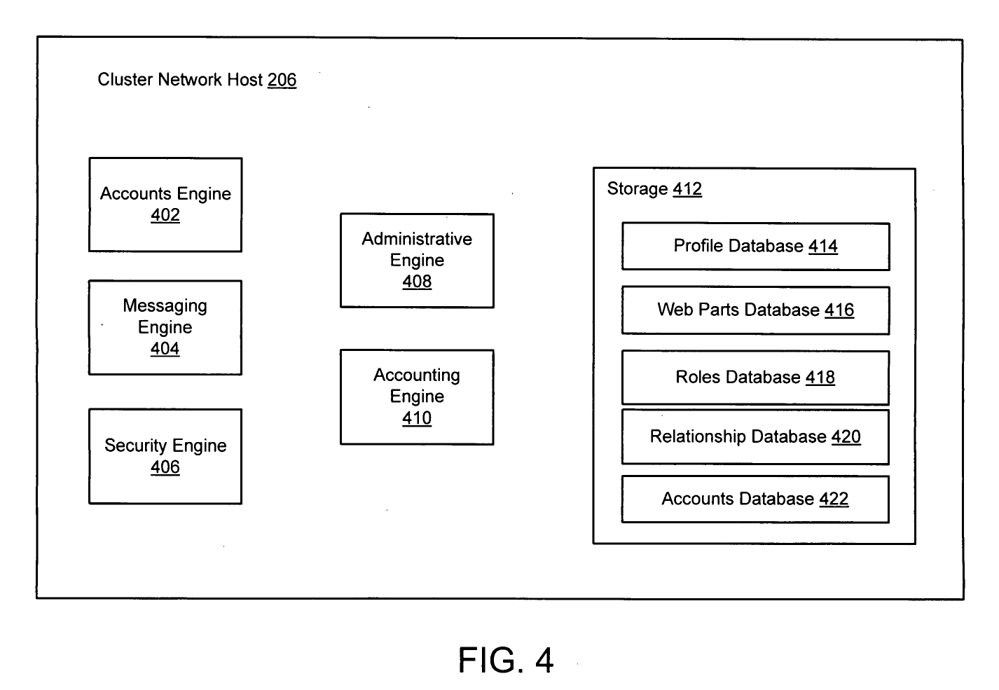

The plurality of group-centric networks 202 and organizations 204 may be administered via a cluster network host 206. In exemplary embodiments, the cluster network host 206 comprises one or more servers configured to create and maintain the network cluster 104 of group-centric networks representing organizations 204 and groups within the organizations 204 using various mechanisms to establish the organizations 204, groups, subgroups, and their relationships. These mechanisms may be utilized by the organizations 204, groups, subgroups, and individuals (e.g., members) to set up their presence within the network cluster 104. In some embodiments, the super cluster network host 108 comprises the cluster network host 206 or some of the components of the cluster network host 206. The cluster network host 206 will be discussed in more detail in connection with FIG. 4 to FIG. 7.

The organization 204 represents any entity that desires to establish a presence on the network cluster 104. The organization 204 may comprise profit or nonprofit entities, and may be any type of organization, such as businesses, franchises, sponsors, universities, retail chains, advertisers, and partners, city governments and its institutions and citizens, affinity groups, interest groups, or simply groups of people sharing a common interest. The sponsors or partners may be organizations 204 which provide goods or services to other organizations 204 in the network cluster 104.

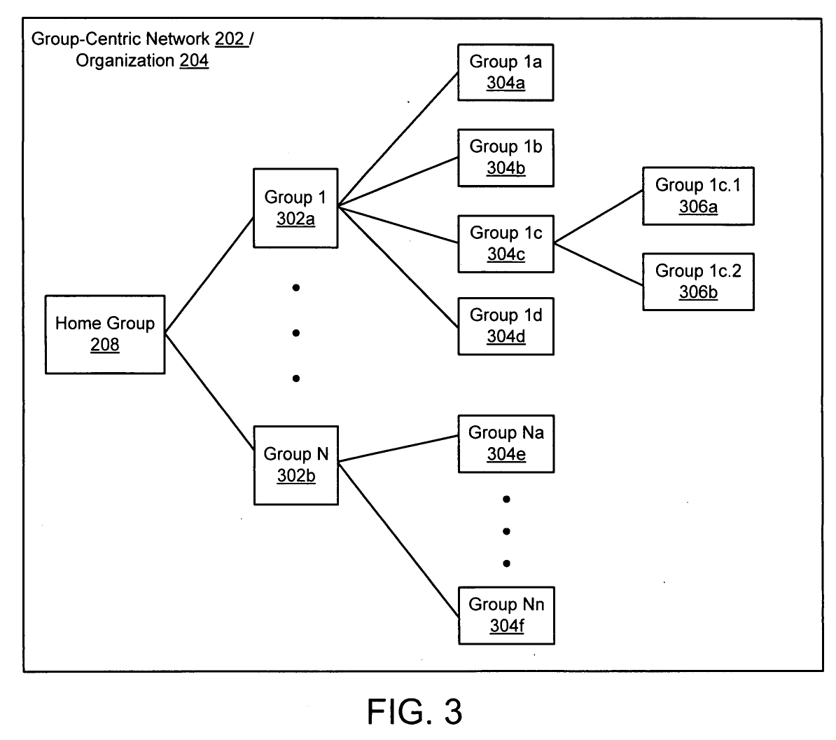

In exemplary embodiments, each organization 204, at a highest level, is represented in the network cluster 104 as a home group 208. The home group 208 is a highest level group in an organization structure that may be established for the organization 204. Each home group 208, in turn, may be linked to one or more subgroups. These subgroups are termed “child groups” of the home group 208 as they are spawns off of the home group 208 or “parent group.” An example of this organizational structure will be discussed in connection with FIG. 3.

It should be noted that FIG. 2a illustrates one exemplary embodiment of the network cluster 104. Alternative embodiments may comprise any number of group-centric networks 202 and organizations 204 coupled to any type of communications network 106. Additionally, more than one cluster network host 206 may be present, and more than one organization 204 or set of organizations 204 may be present in the group-centric network 202.

A specific example of a network cluster (i.e., the cooking network 112) is shown in FIG. 2b. The cooking network 112 comprises a plurality of group-centric networks of cooking related organizations or groups. In the present example, the group-centric network includes networks for French cooking 210, Italian cooking 212, culinary schools 214, and Chinese cooking 216. Within each group-centric network 210-216, a plurality of linked groups or subgroups, as will be discussed in more detail in connection with FIG. 3, is present.

In some embodiments, the network cluster 104 may, itself, include one or more secondary network clusters 104 nested within it. For example, the cooking network 112 (i.e., network cluster 104) may comprise a French cooking cluster 210 (i.e., secondary network cluster), which in turn, includes a pastries group-centric network 218. In another example, a car enthusiast network cluster may comprise a sports car secondary network cluster that includes a hot rod group and a Mustang group. Any number of secondary network clusters 104 may be nested within a primary network cluster 104. Furthermore, any number of levels of clustering may be provided. For example, the pastries group-centric network 218 may actually be a pastries network cluster having a croissant group-centric network.

In further embodiments, a group-centric network 202 may exist within two or more network clusters 104. As illustrated in FIG. 2c, Green Church 220 (i.e., a group-centric network 202) is a member of both the Christian network 110 and environment network 114, whereby the Christian network 110 and environment network 114 are both network clusters 104.

Similarly, a group-centric network 202 may be a member of two nested network clusters 104. For example and referring back to FIG. 2b, Petite Academy 220 is a group-centric network 202 that is a member of both the French cooking (secondary) cluster 210 and the culinary schools (secondary) cluster 214.

As shown, any level of abstraction may be utilized in organizing network clusters 104, nested network clusters, and group-centric networks 202. Furthermore, overlaps in network clusters 104 and nested network clusters may occur at any level and between any number of such network clusters 104.

Referring now to FIG. 3, an exemplary organizational structure for the organization 204 (e.g., a group-centric network 202) is shown. The overall organization 204 is represented in the network cluster 104 as the home group 208. The home group 208 may comprise (e.g., be linked to) one or more child groups. In FIG. 3, the home group 208 is shown directly coupled to a plurality of child groups (group 1 302a through group N 302b). Any number of these first level child groups 302 may be coupled to the home group 208. For example, if the organization 204, and thus the home group 206, represents Wood River Church on the Christian network 110, then the child group 1 302a may represent Small Groups Ministry of the Wood River Church. The groups 208 and 302-306 are entities that have a level of importance similar to an individual. That is the groups 208 and 302-306 may comprise profiles, profile pages, web pages, role and relationships (e.g., permission rights set for different roles of members), and catalog of web parts (e.g., components used to build web pages).

Furthermore, each first level child group 302 may be coupled to one or more second level child groups. As shown, child group 1 302a comprises a plurality of second level child groups (e.g., group 1a 304a through group 1d 304d). Similarly, child group N 302b is coupled to a plurality of second level child groups (group Na 304e through group Nn 3040. Any number of second level child groups 304 may be established and coupled to the first level child group 302. As a result, the first level child group 302 becomes a parent to the second level child group 304. Alternatively, the first level child group 302 may not be coupled to any second level child groups 304.

Continuing with the example, the Small Groups Ministry may comprise a plurality of small ministry groups, each small ministry group comprising at least one leader and one or more members. These small ministry groups may be referred to as child groups of the Small Group Ministry, which is a parent to the small ministry group.

As further shown, the second level child group 304, itself, may be a parent to third level child groups 306. The organizational structure allows any number of levels of child groups to be established within a single organization 204. Additionally, any number of parent-child relationships may be established within the organizational structure represented on the communication network 106 with any specific child group having one parent.

Each group within the organization 204 (e.g., home group 208, child groups 302-306) as well as each user (e.g., individual member) may be defined by its profiles, functions (e.g., web parts), and relationships (e.g., friends, members, etc.). The profile may be extended to include profile specific pages for that type of group, and users connected to (e.g., members of that group may have their personal profiles extended with user information pertinent to that type of group. The group information may include, for example, characteristics, purpose, identification of a group leader, and contact information for the group leader. The user information may comprise contact information, interest areas, photos, etc. Depending on the network cluster 104 and the subject matter of the network cluster 104, profile segments and associated catalog of web parts (e.g., for creating the profile and web pages and providing functionality) for each group 208, 302-306 and user may differ between different network clusters 104.

The profiles or web parts may also comprise security settings for the groups 208, 302-306 as well as for each individual user in the network cluster 104. According to one embodiment, the profile or web parts may comprise general security settings for all data associated with the group 208, 302-306 or user. For example, only logged in group members may be allowed to access data on a group's web page. Alternatively, the profile or web parts may set default security settings for each component on a web page created for the group or user. In some embodiments, the components may comprise different security settings such that some data may be accessed only by group members, and other data, for example, may be accessed by the public or friends. It should be noted that similar profiles, profile segments, and web part functionalities as well as security settings may be applied to network clusters 104.

Each organization 204 may be represented in the network cluster 104 as an organizational structure comprising groups 208, 302-306 networked together through various relationships. These relationships establish how each group 208, 302-306 is coupled within the organizational structure to other groups 208, 302-306 and individual users. Exemplary relationships may comprise line relationships, lateral relationships, staff relationships, functional relationships, group membership relationships, and individual membership relationships. The line relationship comprises a direct parent-child relationship between two groups 208, 302-306 in the organizational structure. For example, there is a parent-child relationship between the home group 208 and first level child group 1 302a.

The lateral relationship comprises a relationship between groups on the same hierarchical level. In the example of FIG. 3, there is a lateral relationship between child group 1 302a and child group N 302b.

The staff relationship comprises a relationship between, for example, an administrative group and other groups 208, 302, 304, or 306 for advisory purposes. For instance, an information technology group may form relationships with a plurality of child groups 302-306 in order to provide technical assistance.

The functional relationship may comprise a relationship between a special purpose group and other groups 208, 302, 304, or 306. In some embodiments, this relationship comprises a line relationship that relates to the special function of the group. In one embodiment, the relationship of the special purpose group (e.g., church store) may allow a member of the special purpose group to access and change data on a webpage of another group. For example, a member of the church store may access and edit advertisement for the church store on a group's webpage.

The group membership relationship comprises a relationship that establishes that a group belongs to an organizational structure. This relationship is, in some embodiments, established with the home group 208 of the organization 204. In other embodiments, membership may be between two independent organizations 204 (each one with its own home group 208), wherein one organization 204 is a member of the other organization 204. An example of this comprises a church denomination and its churches. Both are organization 204 having independent group hierarchies with their own home groups 208. However, there is a membership relationship between the home group 208 of each church (e.g., organization 204) of that denomination and an organization 204 of the church denomination hierarchy. A specific example comprises the Orlando Church of the Nazarene, which is a member of the Nazarene Denomination through a relationship of the Orlando Nazarene Church home group with the group “South East Region” of the Nazarene Denomination hierarchy.

The individual membership relationship comprises relationships established between an individual user and the groups 208, 302-306 making that individual a member of that group 208, 302-306. Members comprise individuals that participate in the group 208, 302-306 in different roles. The roles may comprise leaders, project managers, general members, and so forth. The user may also have a role as a “friend” or as “public” (e.g., not logged in or not a direct member of the group in question). These roles and relationships may be defined by the group-centric network 202 for its groups 208 and 302-306 (e.g., by an administrator).

Furthermore, there may be two types of relationships: within the organization 106 and outside of the organization 204. Within the organization 204, there are relationships between groups 208 and 302-306 (e.g., parent and child) and individual relationships (e.g., member, leaders). Outside of the organization 204, relationships may be established between different organizations 204 (e.g., sponsorship, partnership, etc.). In some embodiments, the establishment of relationships may be based on criteria. For example, if a sponsor is looking to sponsor Baptist churches within a 20 mile radius, then a church (i.e., organization 204) fitting these criteria may establish a relationship with this sponsor.

Once activated, each group 208, 302-306, as well as users, may be represented on the communication network 106 by one or more web pages. These web pages may reflect the group's profile, functions, relationships, leadership, and members. As such, the web pages may be customized by each group 208, 302-306 or user.

It should be noted that all of the relationships described within and between group-centric networks 202 may be applied at the network cluster 104 level. For example, two related group-centric networks 202 may have a lateral relationship. In another example, one network cluster 104 may be a parent to another network cluster 104 (i.e., nesting of one network cluster 104 in another).

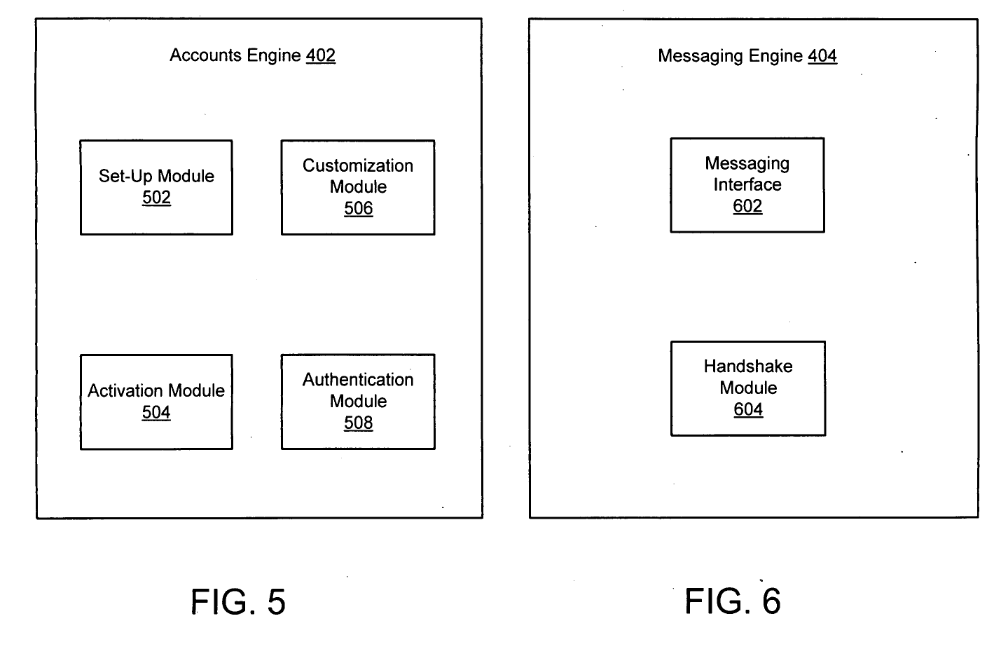

Referring now to FIG. 4, the cluster network host 206 is shown in more detail. In exemplary embodiments, the cluster network host 206 comprises an accounts engine 402, a messaging engine 404, a security engine 406, an administrative engine 408, an accounting engine 410, and storage 412. The exemplary accounts engine 402 is configured to manage the group-centric networks 202 within the network cluster 104, and will be discussed in more details in connection with FIG. 5.

The exemplary messaging engine 404 is configured to provide mechanisms to communicate within the communication network 106 including providing handshake mechanisms for creating, administering, and maintaining the group-centric networks 202 within the network cluster 104. The messaging engine 404 will, in exemplary embodiments, generate and forward messages (e.g., e-mails) to, and between, individuals (e.g., group leaders, administrative staff, users, etc.) of the group-centric network 202. The messaging engine 404 will be discussed in more detail in connection with FIG. 6.

In exemplary embodiments, the security engine 406 limits access and functions within the network cluster 104 and the group-centric networks 202 based on roles and relationships in the group-centric network 202 and privacy settings of data. For example, some data posted on the group's page may be made private. This private data may only be accessed by, for example, a group leader. In other embodiments, the access for each piece of data may be set in a profile or on a page for the data which is established when the data is posted to the web page (e.g., via a web part). In various embodiments, there are a plurality of levels of access and functionality based on an individual's role such as, for example, public, member, leader, friend, and administrator. Additionally, sets of individuals within these roles may be established for viewing and functional access (e.g., a set of friends or leaders may view data). The security engine 306 will determine based on these levels of access whether an individual accessing the data is permitted to view the data. In another example, an administrator of a group-centric network 202 may be allowed to define or refine the group-centric network profile segments and elements and web parts catalog. However, a member of the group-centric network 202 will only be allowed to enter the data in his instance of the profile extensions appended to his original profile.

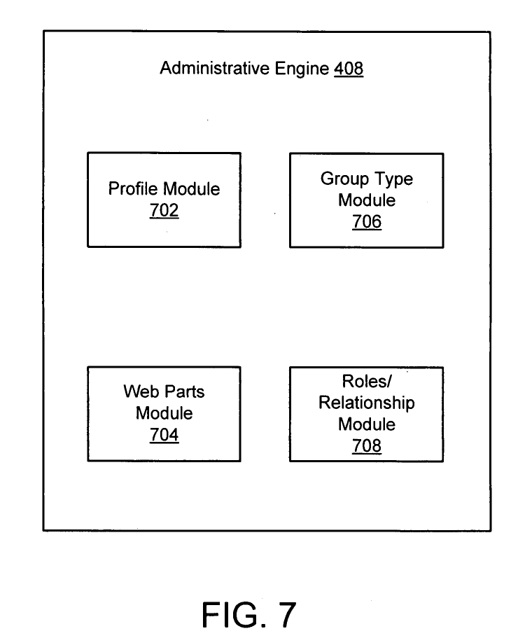

The exemplary administrative engine 408 works with the accounts engine 402 to establish a group-centric network 202 in the network cluster 104. Specifically, the administrative engine 408 allows an administrator to define group-centric administrative components (e.g., profile segments, web parts, roles) for groups (e.g., groups 302-306) within the group-centric network 202. In some embodiments, the administrative engine 408 may be a part of the accounts engine 402. The administrative engine 408 will be discussed in more details in connection with FIG. 7.

The exemplary accounting engine 410 is configured to maintain accounting and billing information for each group-centric network 202. In various embodiments, each group-centric network 202 subscribes to a particular level of service with the cluster network host 206. The level of service may determine a certain number of megabytes of storage and bandwidth on the communication network 106 and types of features (e.g., customized catalog of web parts) available to the group-centric network 202, for example.

The storage 412 is configured to store various databases associated with the network cluster 104 and group-centric networks 202. In exemplary embodiments, the storage 412 comprises a profile database 414, web parts database 416, roles database 418, relationship database 420, and accounts database 422. These databases 414-422 are exemplary and alternative embodiments may comprise more or less databases or combine some of the databases 414-422 together. For example, other databases may provide layouts and themes, or store events, news, and blogs for the network clusters 104 or group-centric network 202.

The exemplary profile database 414 may store profile information for each group-centric network 202, organization 204, group 208 and 302-306, and individual (e.g., individual users who are members of the network cluster 104 or one of the group-centric networks 202 in the network cluster 104) within the network cluster 104. Profile information may comprise name, contact information, security settings, preferences, attributes, history, and so forth. For each group-centric network 202, a general profile may be established. In some embodiments, the general profile will comprise default settings including default security settings that will apply to various web part components or data provided by the group-centric network 202. In some embodiments, the profile database 412 may also comprise profile segments associated with the network cluster 104, group-centric network type, and/or groups, as will be discussed in more detail below.

In exemplary embodiments, the web parts database 416 comprises components that are provided to customize a web page of group-centric networks 202, groups, and/or individual users. Icons representing these web parts may be shown, for example, on a pop-up window or on a side of the web page during web page customization. An administrator for a group-centric network 202 or groups within the group-centric network 202, for example, may define new web parts to provide to a catalog of available web parts for a group. The administrator may also drag and drop an appropriate icon onto a location of the web page where the selected component should appear in order to customize the group-centric network 202 or group web page. If a user connects to the group, his catalog of available web parts will be augmented with the web parts made available by the administrator. Similarly, an individual member (i.e., user) may drag and drop web parts onto their personal web page to customize their web page. In various embodiments, the web parts components also enable functions on the web pages. In exemplary embodiments, customized catalogs of web parts that are available to each group and members of the group may be provided from the web parts database 416.

Each web part component may also allow the individual to select or set a security setting for access to data for that web part. As such, web part security is based on roles and relationships which determine functionality and access rights available to a user accessing the web part on the group or user web page. For example, a group-centric network web page may have an events web part. The events web part may be configured to be viewed by anyone (e.g., guests, members), but only leaders of the group-centric network 202 are allowed to post new events in the events web part. In some embodiments, these security settings may not be profile based but are specified by editing the web part settings.

The roles database 418 may, in some embodiments, store an individual's roles (e.g., responsibilities and permissions within groups) with respect to the network cluster 104 and/or the group-centric network 202. These roles may, in one embodiment, be based on relationships between individuals and the home group 208 and/or child groups 302-306 as well as the network cluster 104. These roles may, for example, identify an individual as a leader of the home group 208 (e.g., power over functions performed within the home group 208 and the organization 204 and has access to all information handled by the home group 208), officer or member (e.g., has limited powers to perform functions and access information as defined by the group manager), administrator (e.g., responsible for technical and administrative maintenance of the organization 204), friend (e.g., not a member by a known individual associated with the user), or guest (e.g., public which may be registered or unregistered with the network cluster 104 or group-centric network 202). As a result, the role of the individual determines access and functionalities enabled for the individual within the network cluster 104 and the group-centric network 202.

The exemplary relationship database 420 may comprises tables storing relationships between the various organizations 202, groups 208 and 302-306 and individuals within the network cluster 104. Such relationships may include, but are not limited to, parent-child relationships, sponsor-organization relationships, partner-organization relationships, members-group relationships, and advertise-organization relationships. In some embodiments, the roles database 418 and the relationship database 420 may be combined.

The exemplary accounts database 422 is configured to store account information for group-centric network 202 and individual users within the network cluster 104. In some embodiments, the account information may include the defined administrative components as will be discussed in FIG. 7.

FIG. 4 has been discussed in relations to the cluster network host 206. However, some of the engines and databases of FIG. 4 may be embodied within the super cluster network host 108. It should also be noted that the embodiment of FIG. 4 is exemplary and that alternative embodiments may comprise more, less, or other functionally equivalent components.

Referring now to FIG. 5, the exemplary accounts engine 402 is shown. The accounts engine 402 is configured to create and maintain group-centric networks 202 and groups within the group-centric network 202 (e.g., home group 208 and groups 302-306), as well as individual user accounts. In exemplary embodiments, the accounts engine 402 comprises a set-up module 502, activation module 504, customization module 506, and authentication module 508.

The exemplary set-up module 502 is configured to receive account information for account set-up. In exemplary embodiments, the account is for a group-centric network 202, group 208 or 302-306 within the group-centric network, or individual user. In one embodiment, the request may be received via a graphical user interface. The graphical user interface may provide a plurality of fields where an individual establishing the account enters information such as, for example, contact information, profile and relationship information, billing and service plan information, and so forth.

In accordance with some embodiments, an account may be created based on the request, but the account may be inactive until activated by the activation module 504. With respect to a request to create a new group-centric network 202, the request (e.g., account information) may be filtered through a plurality of criteria to determine if the group-centric network is approved. The filtering may be performed manually or automatically (e.g., by the set-up module 502 or activation module 504). If all criteria are met, the account may be activated.

With respect to activation of a group-centric network 202 or groups 208 and 302-306, the activation may also be based on an approval process utilizing handshake mechanisms. For example, if a new group-centric network 202 wants to be established within the network cluster 104, a handshake process (e.g., a “belong” request or handshake) may be performed for approval and activation of the new group-centric network 202. The handshake process will be discussed in detain in connection with FIG. 6.

Approval and activation within the network cluster 104 may also include approving an established group-centric network 202 within the network cluster 104. In a further example and referring back to FIG. 3c, if the Green Church 220 is established within the Christian network 110, but wants to extend to be a part of the environment network 114, a request (e.g., “join” request or handshake) to the environment network host may be necessary. In this embodiment, the activation module 504 is configured to perform the approval process. In one embodiment, the activation module 504 may trigger the messaging engine 404 to perform a message-based handshake between the Green Church 220 and the environment network host. Assuming, the environment network host approves, the Green Church (e.g., administrator) will be notified and appropriate extensions (e.g., profile segments, web parts, group types, roles) are provided to the Green Church and its members.

The exemplary customization module 506 is configured to allow the customization of the group-centric network 202, group 208 and 302-306, or individual user web page. In exemplary embodiments, a default web page is initially provided. Web part components may, in some embodiments, be used to customize the web page. In some embodiments, the customization module 506 provides access to a catalog of these web part components stored in the web parts database 416. When membership is extended to a new group 208 and 302-306 or network cluster 104, the customization module 506 may provide the profile extensions (e.g., new profile segments for the new group or network cluster 104) and append the catalog of web parts available to the user to extend their web page. Super cluster web parts may be generic web parts, while network cluster and group web parts are customized (i.e., defined) for the network cluster 104 and groups.

The exemplary authentication module 508 authenticates individuals accessing the network cluster 104 and group-centric networks 202. In some embodiments, the authentication module 508 will verify a user identifier and password for an individual access the network cluster 104 and group-centric networks 202 by comparing the user identifier and password with one stored in the profile database 414. Once authenticated, the individual may access data or perform actions based on their roles (e.g., as determined based on data in the roles/relationship database 418) within the super cluster 102.

Referring now to FIG. 6, the exemplary messaging engine 404 is shown. The messaging engine 404 is configured to enable communication (e.g., e-mails) within the network cluster 104. These communications may include message-based handshakes. Handshakes comprise message exchanges which may be used to established relationships between group-centric networks 202, groups 208 and 302-306, and individuals within the network cluster 104. The messaging engine 404 may comprise a messaging interface 602 and a handshake module 604.

The exemplary messaging interface 602 is configured to provide a graphical interface through which a handshake mechanism (e.g., an e-mail) may be composed and sent. In some embodiments, the messaging interface 602 may display a template for a particular handshake type. The template may comprise fields in which information may be inputted.

In some embodiments, the handshake or template type may be provided by the handshake module 604. For example, a user may select a handshake or template type from a drop down menu or listing of handshakes provided by the handshake module 604. There are different handshake types based on roles or relationships (or potential roles and relationships). For example, a specific handshake may be utilized to request to establish a new group-centric network in the network cluster 104. This handshake may be referred to as a “belong” handshake (i.e., to create a group that belongs to the network cluster 104).

In another example, the handshake may be directed to approval/activation of a group-centric network 202 in a second network cluster 104 (i.e., to cause an overlap in network clusters as shown in FIG. 3c). This handshake may be referred to as a “join” handshake (i.e., to join a network cluster 104). The “join” handshake may be exchange with a network administrator of the network cluster 104 the established group-centric network 104 would like to join.

The handshake may also comprise an “invitation” handshake, which invites the creation of a new role or relationship. For example, the environment network 114 (via an administrator) may invite the Green Church 220, which is a group-centric network 202 in the Christian network 110, to also establish itself as a group-centric network 202 in the environment network 114.

Referring now to FIG. 7, the exemplary administrative engine 408 is shown. When a group-centric network 202 is established within the network cluster 104, components for the group-centric network 202 may be defined (e.g., the subject matter and content of the group-centric network 202), for example, by the network cluster administrator via the super cluster network host 108. However, group-centric networks 202 may comprise many levels of groups and subgroups which require their own customized set of administrative components, which may not be contemplated at the network cluster level by the network cluster administrator. As such, the administrative engine 408 is provided in the cluster network host 206 to allow administrators of the group-centric network 202 or groups (e.g., groups 302-306) within the group-centric network 202 to further define or refine administrative components for their groups. These administrative components may include profile segments, web parts, group types, and roles/relationships for groups (e.g., groups 302-306) within the group-centric network 202. As such, each group within the group-centric network 202 may have customized administrative components available to their members. The exemplary administrative engine 408 may comprise a profile module 702, web parts module 704, group type module 706, and roles/relationship module 708. It should be noted that in some embodiments the functionalities of the administrative engine 408 may be associated with the accounts engine 402. In an alternative embodiment, if a group-centric network 202 is complex or large enough that it requires further administrative components, the group-centric network 202 may be made into its own nested cluster.

Additionally, some or all of the functionalities of the administrative engine 408 may be located at the super cluster network host 108. For example, administrative components for the network cluster 104 and the group-centric network 202 (e.g., home group 202) may be defined at the super cluster network host 108, but administrative components for individual groups (e.g., groups 302-306) within the group-centric network 202 may be defined with the administrative engine 408 of the cluster network host 206.

The profile module 702 is configured to define the profile segments for the groups (e.g., groups 302-306) within the group-centric network 202. The administrator of the group-centric network 202 or group may define and establish the profile segments for their groups (e.g., groups 302-306). A profile segment comprises a profile entry or data elements that are directed to a profile of a user. For example, a missionary group within the Green Church may have a profile segment “My Missions.” These profile segments may be utilized to generate the user's profile.

The web parts module 704 is configured to define the web parts for the groups 302-306. Web parts comprise components or programs used to build group or individual pages (i.e., web pages). Continuing with the previous examples, the missionary group may have a “Cause Offering” web part component, while a youth ministry subgroup of the missionary group may have a “My Adventures in Service” web part. The administrator of the group-centric network 202 may establish the web parts for the groups in the group-centric network 202, for example, by dragging and dropping from a web parts catalog into a group page (e.g., by an administrator for the group) or individual pages.

The exemplary group type module 706 establishes various subgroup types for the group-centric network 202. These subgroup types may define the types of subgroups (e.g., groups 302-306) that are established within the group-centric network 202. For example, a “mission ministry” subgroup type may be defined for the “church” group type. Thus, the administrator for the group-centric network 202 may, for example, define or create groups using subgroup types based on group types previously defined by the network cluster administrator.

The roles/relationship module 708 is configured to define further roles and relationships for the groups within the group-centric network 202. Each group-centric network will have customized roles and relationships which may determine access and functionality for groups and individuals within the group-centric network 202. Thus, when a group (e.g., groups 302-306) is established within a network cluster 104, an administrator of group-centric network 202 or the group defines entitlements for a user to data and functions within the group in terms of a user's role or relationship with the group. Via the roles/relationship module 708, the administrator may define different functional behavior and data visibility (e.g., data access) for each different relationship that a user may have with the group. Even if the user does not have a relationship (e.g., guest or public) with the group, different functional behavior and data visibility may be defined based on the user's role and relationship with the network cluster 104 or super cluster 102. This allows for different functional behavior and data visibility to anonymous users, super cluster members, network cluster members, and group-centric network members.

For example, an administrator for the French cooking group 210 in the cooking network (cluster) 110 can define that a user accessing the French cooking group 210 may see recipes if he is a member of the cooking network 110 even if the user is not a member of the French cooking group 210. Because, the user is a member of the cooking network 110, the user is given access rights to the recipes. Continuing with this example, an anonymous user or a super cluster member who is not a member of the cooking network 110 will not be able to see the recipe. Furthermore, the administrator for the French cooking group 210 may define that only users who are both members of the French cooking group 210 and have a role of a chef within the French cooking group 210 are allowed to post recipes with the French cooking group 210 (i.e., role=chef; relationship=within the French cooking group 210). Any combination and any number of combinations of roles/relationships may be defined for each organization 204 and/or groups 302-306. It should be noted that security settings on data profiles for the data posted on the web page may override the roles/relationship definitions.

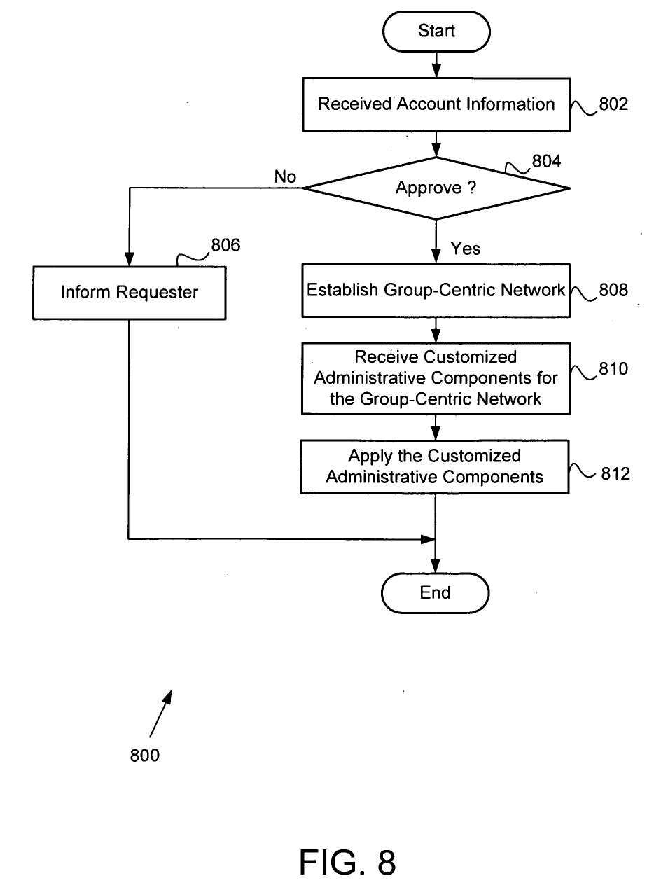

Referring now to FIG. 8, a flowchart 800 of an exemplary method for managing a network cluster 104 is shown. In step 802, account information for establishing a group-centric network 202 within the network cluster 104 is received. In exemplary embodiments, the account information may be provided from a user (e.g., administrator) interested in establishing a group-centric network 202 within a particular topic-specific network cluster 104. In one embodiment, the account information may be for an established group-centric network 202 in one network cluster 104 to join a second network cluster 104, thus causing an overlap of network clusters 104.

A determination is made in step 804 as to whether an account based on the account information is approved or activated. In some embodiments, the set-up module 502 is configured to filter the account information in order to determine if the account is approved. The filtering may be based on criteria and may be performed manually or automatically. In other embodiments, a handshake mechanism is performed to determine if the account should be approved. In various embodiments, the handshake mechanisms may comprise “belong” handshakes and “join” handshakes. In some embodiments, the handshakes may be provided to a network administrator for the network cluster 104 who will approve or deny the activation of the group-centric network 202. If the account information is provided based on an “invitation” handshake, then the account may be automatically approved and activated.

If the account is not approved, then the user is informed that the group-centric network is denied in step 806. In some embodiments, suggestions may be provided to the user to modify aspects of the request (and thus the group-centric network 202) in order to result in a request that will be likely approved.

If the request is approved, then in step 808, the group-centric network 202 is established in the network cluster 104. In exemplary embodiments, establishing the group-centric network 202 may comprise activating the account within the network cluster 104 and providing certain functionalities to an administrator of the created group-centric network 202.

Once the group-centric network 202 is established, customized group-centric administrative components for the group-centric network 202 may be defined in step 810. In exemplary embodiments, the user/administrator for the group-centric network 202 (and/or the groups within the group-centric network 202) may define administrative components specific to their group-centric network and their groups. The customized administrative components may comprise profile segments, web parts, subgroup types, and roles/relationships. More specifically, roles and relationships with respect to access and functionalities to data within the groups (e.g., groups 302-306) of the group-centric network 202 may be defined.

In step 812, customized administrative components may be applied. In embodiments where members join specific groups (e.g., groups 302-306) of the group-centric network 202, the members may be provided with the customized administrative components (e.g., profile extensions and web parts) established for the specific groups of the group-centric network 202. In embodiments where web pages of groups are accessed by users, administrative components associated with the roles and relationships are applied. Thus, a determination may be made as to the user's role and relationship with respect to the accessed group's web page or data. Based on the role and relationship, different levels of access or functionality may be provided to the user.

It should be noted that the method of FIG. 8 is exemplary. Alternative embodiments may comprise more, less, or other steps and still be within the scope of the present embodiment. For example, step 804 may be optional. Additionally, steps may be practiced in a different order.

The above-described functions and components can be comprised of instructions that are stored on a computer (i.e., machine) storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for managing a plurality of group-centric networks, comprising:
receiving account information for a group-centric network; and
establishing the group-centric network within a network cluster, the network cluster comprising one or more group-centric networks having a common interest.

2. The method of claim 1 wherein receiving the account information comprises receiving account information in response to an invitation handshake.

3. The method of claim 1 wherein establishing group-centric network comprises defining profile segments associated with a group within the group-centric network.

4. The method of claim 1 wherein establishing group-centric network comprises defining web parts associated with a group within the group-centric network.

5. The method of claim 1 wherein establishing group-centric network comprises defining at least one subgroup type associated with a group within the group-centric network.

6. The method of claim 1 wherein establishing group-centric network comprises defining roles and relationships associated with at least one group within the group-centric network, the roles, in part, determining access and functionality associated with data from the at least one group.

7. The method of claim 6 further comprising providing access and functionality to data from the at least one group to a user based on a role and relationship of the user with the at least one group.

8. The method of claim 1 wherein establishing the group-centric network comprises performing a message-based handshake mechanism to establish the group-centric network.

9. The method of claim 8 wherein the message-based handshake comprises a join handshake, the join handshake requesting approval of the group-centric network to join the network cluster.

10. The method of claim 8 wherein the message-based handshake comprises a belong handshake, the belong handshake requesting approval of the group-centric network within the network cluster.

11. The method of claim 1 wherein establishing the group-centric network comprises filtering the account information against preset criteria.

12. A system for managing a plurality of group-centric networks, comprising:
a set-up module configured to receive account information for a group-centric network; and
an activation module configured to establish the group-centric network within a network cluster, the network cluster comprising one or more group-centric networks having a common interest.

13. The system of claim 12 further comprising a messaging engine configured to performing a message-based handshake.

14. The system of claim 13 wherein the message-based handshake is an invitation handshake.

15. The system of claim 13 wherein the message-based handshake is a join handshake.

16. The system of claim 13 wherein the message-based handshake is a belong handshake.

17. The system of claim 12 further comprising a profile module configured to establish one or more profile segments associated with a group within the group-centric network.

18. The system of claim 12 further comprising a web parts module configured to establish one or more web parts associated with a group within the group-centric network.

19. The system of claim 12 further comprising a roles/relationship module configured to define roles and relationships associated with at least one group within the group-centric network, the roles, in part, determining access and functionality associated with data from the at least one group

20. A machine-readable medium having embodied thereon a program, the program having instructions operable by a machine for managing a plurality of group-centric networks, the method comprising:
receiving account information for a group-centric network; and
establishing the group-centric network within a network cluster, the network cluster comprising one or more group-centric networks having a common interest.
